(19) United States
(12) Patent Application Publication
(10) Pub. No.: US 2014/0133513 A1
(43) Pub. Date: May 15, 2014

(54) LASER DEVICE AND METHOD FOR GENERATING LASER LIGHT

(71) Applicant: INDUSTRIAL TECHNOLOGY RESEARCH INSTITUTE, Hsinchu (TW)

(72) Inventors: Shih-Ting LIN, Tainan City (TW); Chih-Lin WANG, Tainan City (TW); Yao-Wun JHANG, Chiayi City (TW); Chieh HU, Chiayi City (TW); Hong-Xi TSAU, Tainan City (TW)

(73) Assignee: INDUSTRIAL TECHNOLOGY RESEARCH INSTITUTE, Hsinchu (TW)

(21) Appl. No.: 13/722,469

(22) Filed: Dec. 20, 2012

(30) Foreign Application Priority Data
Nov. 9, 2012 (TW) 101141895

(51) Int. Cl. H01S 1/04; H01S 1/00

(52) U.S. Cl. CPC H01S 1/04; H01S 1/00
USPC 372/51; 372/39

(57) ABSTRACT

A laser device including a laser crystal, a first lens, an induced light source, a third light source and a second lens and a method for generating a laser light are disclosed. The laser crystal includes a gain medium, a first cross section and a second cross section. The first lens is located on the first cross section of the laser crystal. The induced light source is adapted to generate an induced light entering into the laser crystal through the first lens. The third light source is adapted to generate a third light which is adapted for emitting the laser crystal. The third light and the induced light are adapted to induce the liquid crystal to make the liquid crystal generate a first light and a second light.

### CROSS-REFERENCE TO RELATED APPLICATIONS

This non-provisional application claims priority under 35 U.S.C. §119(a) on Patent Application No(s). 101141895 filed in Taiwan, R.O.C. on Nov. 9, 2012, the entire contents of which are hereby incorporated by reference.

### BACKGROUND

1. Technical Field

The disclosure relates to a laser device and a method for generating a laser light, and more particularly, to a laser device using an induced light to enhance conversion efficiency of a laser light associated with certain wavelength and a method for generating the same laser light.

2. Related Art

As a result of advancing in medical technology in recent years, options of having the personals body/health more closely monitored and even cured in the non-invasive way have been accessible by many people. Laser treatment, one of the non-invasive approaches, gains the popularity when it comes to diagnosis and curing of diseases. The laser treatment generally relies on interactions between the laser light and the human tissues. For example, in surgical application, applying the laser light to the human body could cause the human tissues to absorb part of the energy of the laser light and therefore heat the human tissues to 60 to 80 degrees Celsius for stopping the bleeding. Furthermore, when the patient is irradiated by the laser light, the additional amino acids could be produced for alleviating the pain, with the laser light further effectively cutting down the allergy, inflammation as well as helping treat the wound. On the other hand, the laser light has been widely applied in the fields of communications such as computer data optical fiber networks, environmental protection, monitoring, and military, as the laser light inherently is associated with high directivity (i.e., a very small divergence angle), high signal carrying capacity and superior confidentiality in terms of vulnerability to being hijacked. Moreover, a semiconductor-based laser light that is smaller in size, cheaper in manufacturing cost, modified in a relatively easier fashion, and capable of being incorporated into an integrated circuit (IC) is quite suitable for being employed in portable communications systems and serving as the light source for the computer data optical fiber networks.

Conventionally, mid-infrared laser systems are used for bio-medical treatment purpose despite the conversion efficiency thereof remains to be desired because of the distribution of the energy level configuration in a laser crystal. In normal conditions, a pumping light source generally involves transitions of the atoms between the energy levels, which result in the emission of lights of different wavelengths between the energy levels. Accordingly, the conversion efficiency of the light with certain wavelength in certain energy level will be relatively low and therefore it needs to be improved.

### SUMMARY

An embodiment of the disclosure provides a laser device comprising a laser crystal, a first lens, an induced light source, a third light source and a second lens. The laser crystal includes a gain medium, a first cross section and a second cross section. The first lens is located on the first cross section of the laser crystal. The induced light source is adapted to generate an induced light entering into the laser crystal through the first lens. The third light and the induced light are adapted to induce the liquid crystal to make the liquid crystal generate a first light and a second light. The second lens is located on the second cross section of the laser crystal. The first lens and the second lens are adapted to reflect the induced light, the first light and the second light.

Another embodiment of the disclosure provides a method of generating a laser light. The method comprises the following steps. A third light associated with a third wavelength is emitted into a laser crystal. The laser crystal comprises a gain medium. The gain medium enables the laser crystal to have a first energy level, a second energy level, and a third energy level. Each of the first energy level, the second energy level, and the third energy level has a plurality of atoms. When the atoms at the third energy level are migrated to the second energy level by transition, a first light associated with a first wavelength is generated. When the atoms at the second energy level are migrated to the first energy level by transition, a second light associated with a second wavelength is generated. An induced light into the laser crystal is emitted to induce the atoms at the second energy level to be migrated to the first energy level by transition. A wavelength of the induced light and the second wavelength differ from each other by less than five percent.

### BRIEF DESCRIPTION OF THE DRAWINGS

The disclosure will become more fully understood from the detailed description given herein below for illustration only, and thus does not limit the disclosure, and wherein:

FIG. 1 is a schematic view of a laser device according to one embodiment of the disclosure;

FIG. 2 is a schematic view of energy levels of the laser device in FIG. 1 according to one embodiment of the disclosure;

FIG. 3 is a schematic view of the laser device according to one embodiment of the disclosure;

FIG. 4 is a schematic view of the laser device according to another embodiment of the disclosure;

FIG. 5 is a schematic view of the laser device according to another embodiment of the disclosure;

FIG. 6 shows the results of light source power of the laser device shown in FIG. 1; and

FIG. 7 is a flow chart of a method for generating a laser light according to one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

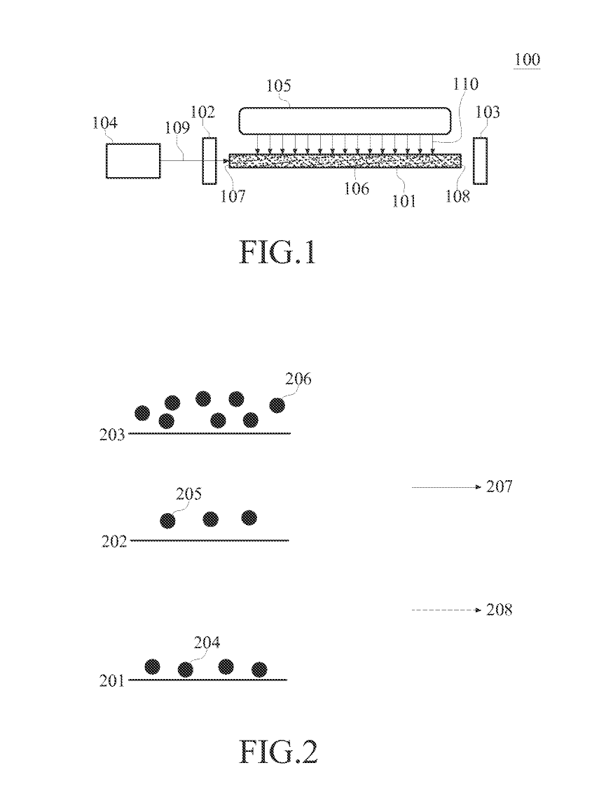

Please refer to FIG. 1, which is a schematic view of a laser device 100 according to one embodiment of the disclosure. The laser device 100 comprises a laser crystal 101, a first lens 102, a second lens 103, an induced light source 104, and a third light source 105.

FIG. 2 is a schematic view of energy levels of the laser device 100 of FIG. 1 according to one embodiment of the disclosure. Please refer to FIGS. 1 and 2, the laser crystal 101 comprises a gain medium 106, a first cross section 107, and a second cross section 108. The gain medium 106 may cause the laser crystal 101 to have a first energy level 201, a second energy level 202, and a third energy level 203.

In this embodiment, the length of the laser crystal may be 10 centimeters (cm), but not limited to the disclosure. The gain medium 106 is erbium and the doping concentration of the gain medium 106 is fifty percent. In other embodiments, the doping concentration of the gain medium 106 may be forty percent or sixty percent. Each of the energy levels (e.g., the first energy level) has a plurality of atoms 204, 205, and 206, respectively. When the plurality of atoms 206 at the third energy level 203 are migrated to the second energy level 202 by transition, a first light 207 associated with a first wavelength may be generated (i.e., radiated). When the atoms 205 at the second energy level 202 are migrated to the first energy level 201 by transition, a second light 208 associated with a second wavelength may be generated.

In addition, the first lens 102 is located at the laser the first cross section 107 and the second lens 103 is located at the second cross section 108. The second lens 103 is adapted to cause the first light 207 with the first wavelength to be reflected from the second cross section 108 while allowing at least eighty percent of the second light 208 with the second wavelength to penetrate into the laser crystal 101. The reflection ratio of the first lens 102 to the first wavelength of the first light 207 is greater than the reflection ratio of the second lens 103 to the first wavelength of the first light 207. The reflection ratio of the second lens 103 to the second wavelength of the second light 208 is greater than the reflection ratio of the first lens 102 to the second wavelength of the second light 208. On the other hand, the penetration ratio of the second lens 103 to the first wavelength of the first light 207 is greater than the penetration ratio of the first lens 102 to the first wavelength of the first light 207, and the penetration ratio of the first lens 102 to the second wavelength of the second light 208 is greater than the penetration ratio of the second lens 103 to the second wavelength of the second light 208. In the above-mentioned description, the first lens 102 or the second lens 103 being reflecting the first light associated with the first wavelength or the second light associated with the second wavelength suggests that the first lens 102 or the second lens 103 effectively reflects eighty percent of the first light 207 or the second light 208 from the first lens 102 or the second lens 103.

As shown in FIGS. 1 and 2, the induced light source 104 is adapted to generate an induced light 109 penetrating into the laser crystal 101 via the first lens 102 and the wavelength of the induced light 109 corresponds to the energy difference between the first energy level 201 and the second energy level 202. Therefore, the induced light 109 may induce the atoms at the second energy level 202 to migrate back to the first energy level 201 by transition, resulting in generating a radiating light associated with a wavelength. The wavelength of the radiation light differs from the second wavelength of the second light 208 by less than five percent. The third light source 105 is a pumping light source and is adapted to generate a third light 110 which emits into the laser crystal 101 through a side surface of the laser crystal 101 for migrating the atoms 204 at the first energy level 201 to the second energy level 202 and the third energy level 203 by transition, or migrating the atoms 205 at the second energy level 202 to the third energy level 203 by transition. In this embodiment, the first wavelength of the first light 207 may be between 2650 nm (nanometer) to 3000 nm, and the second light 208 and the induced light 109 may range from 1500 nm to 1650 nm in wavelength, and the third light 110 may be between 940 nm to 990 nm in wavelength.

Also as shown in FIGS. 1 and 2, since the presence of the gain medium 106 causes the laser crystal 101 to have the first energy level 201, the second energy level 202 and third energy level 203, when the third light 110 is emitted into the laser crystal 101 through the side surface of the laser crystal 101, the atoms 204 at the first energy level 201 may be migrated to the second energy level 202 and the third energy level 203 by transition or the atoms 205 at the second energy level 202 may be migrated to the third energy level 203 by transition. After short periods of average stay, the atoms 206 which are migrated to the third energy level 203 may migrate back to the second energy level 202 by transition as well as generating the first light 207. On the other hand, the atoms 205 which are migrated to the second energy level 202 may migrate back to the first energy level 201 by transition with the second light 208 simultaneously generated. In one embodiment, the short periods for the atoms 205 and 206 to stay at the second energy level 202 and the third energy level 203 may be 6400 microseconds (μm) and 100 μm, respectively.

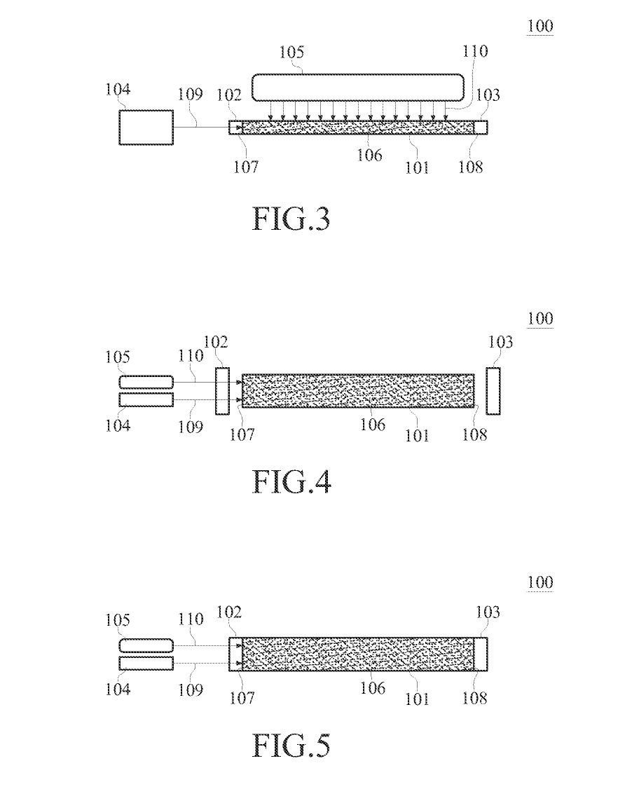

Please refer to FIGS. 3 to 5, which are the laser devices 100 according to different embodiments of the disclosure. The laser devices 100 in FIGS. 3 to 5 are similar to the laser device 100 of FIG. 1. The first lens 102 is directly formed on the first cross section 107 of the laser crystal 101 and the second lens 103 is formed on the second cross section 108 of the laser crystal 101. In other words, the first cross section 107 is in physical contact with the first lens 102, and the second cross section 108 is in physical contact with the second lens 103. The first lens 102 and the second lens 103 may be simultaneously formed over the course of the growth of laser crystal 101. The third light 110 in FIG. 4 may penetrate into the laser crystal 101 through the first cross section 107, when the first lens 102 allows the penetration of the third light 110 having the third wavelength and the second lens 103 reflects the third light 110 having the third wavelength. In the embodiment illustrated in FIG. 5, in addition to the third light 110 penetrating into the laser crystal 101 via the first cross section of 107 as well as the first lens 102 and the second lens 103 formed on the first cross section 107 and the second cross section 108, respectively, the first lens 102 and the second lens 103 may be simultaneously formed on their corresponding locations (i.e., the first cross section 107 and the second cross section 108) over the course of the growth of the laser crystal 101. Meanwhile, the first lens 102 may be penetrated by the third light 110 having the third wavelength while the second lens 103 reflects the third light 110 having the third wavelength. Other aspects of the laser device in FIGS. 3 to 5 such as operational principles and characteristics are similar to those of the laser device 100 described in FIG. 1 and therefore the similarities are not repeated herein.

Because the gain medium 106 may cause the laser crystal 101 to generate two lights associated with two wavelengths, i.e., the first light 207 and the second light 208, the optical gain of the first light 207 may be lowered and thus the conversion efficiency of the first light 207 may be lowered as well. To compensate this, the induced light may be utilized for emitting into the laser crystal 101 by irradiation through the first lens 102, which results in increasing the number of the atoms 205 at the second energy level 202 migrating back to the first energy level 201 by transition. As such, the number of the atoms 205 at the second energy level 202 may be lowered, which results in increasing the atoms 206 migrating back to the second energy level 202 from the third energy level 203 by transition. Accordingly, the conversion efficiency of the first light 207 may be improved.

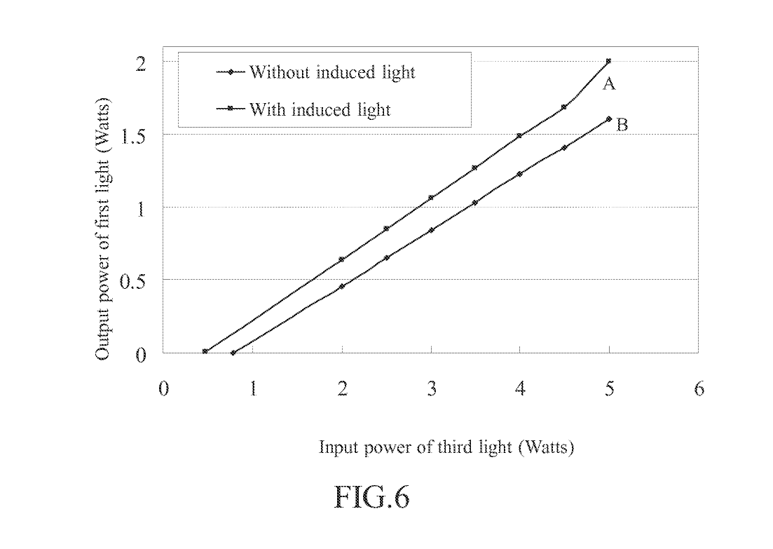

Please refer to FIG. 6, which shows the results of light source power of the laser device 100 illustrated in FIG. 1. the horizontal axis represents an input power (Watt) of the third light 110, and the vertical axis represents an output power of the first light 207 (Watt), when the input power of the third light 110 is 5 Watts the output power of the first light 207 may be 2 Watts with the induced light 109 penetrating into the laser crystal (point A). Also seen from FIG. 6, when the induced light 109 is no longer provided into the laser crystal, the output power of the first light 207 may be at 1.6 Watts (point B) in the event that the input power of the third light 110 remains at 5 Watts. Therefore, when the gain medium 106 is further irradiated by the induced light 109, the conversion efficiency of the first light 207 may be improved and therefore the first light 207 is suitable for bio-medical treatment purpose as well as being a bio-medical treatment light.

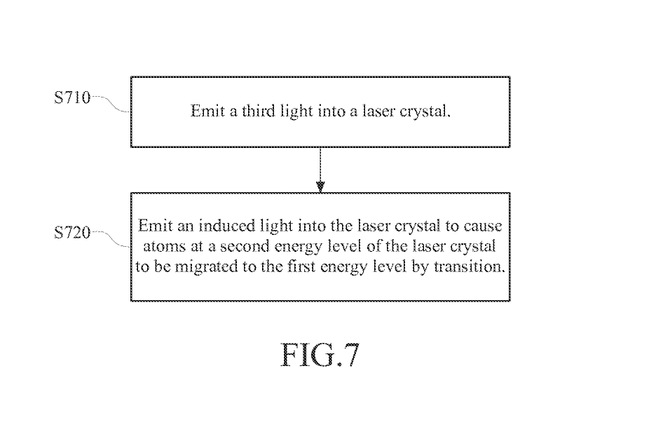

Please refer to FIG. 7, which is a flow chart of a method for generating a laser light according to one embodiment of the disclosure. In step S710, the method includes emitting the third light into the laser crystal having the gain medium, which causes the laser crystal to have the first energy level, the second energy level, and the third energy level. It is worth noting that each of the energy levels may be associated with the atoms. The transitions of the atoms at the third energy level to the second energy level may lead to the generation of the first light associated with the first wavelength. Also, the transitions of the atoms at the second energy level to the first energy level may lead to the generation of the second light associated with the second wavelength. Furthermore, the third light generated by the third light source has the third wavelength.

Next, in step S720, the induced light may be emitted into the laser crystal to cause the atoms at the second energy level to be migrated to the first energy level by transition, and the wavelength of the induced light differs from the second wavelength by less than five percent. It is worth noting that steps S710 and S720 may be performed in a different sequence. In other words, S720 may be performed before S710. In other embodiments, both steps S720 and S710 may be performed simultaneously. The performance of the above-described steps S710 and S720, the conversion efficiency of the first light may be improved for enhancing the suitability of bio-medical treatment and the first light is a bio-medical treatment light.

In summary, compared to the conventional arts, the disclosure employs the single-wavelength excitation for removing the atoms in certain energy levels of the erbium as the gain medium, significantly enhancing the gain of the 2940 nm laser light. The disclosure could reduce the initially energy required for the 2940 nm laser light serving as an induced source pulse light, steadying the system, lowering the input power of a pulse control circuit, and increasing the efficiency of power usage.

What is claimed is:

1. A laser device, comprising:
a laser crystal including a gain medium, a first cross section and a second cross section;
a first lens located on the first cross section of the laser crystal;
an induced light source for generating an induced light entering into the laser crystal through the first lens;
a third light source for generating a third light, the third light being adapted for emitting the laser crystal, wherein the third light and the induced light are adapted to induce the liquid crystal to make the liquid crystal generate a first light and a second light; and
a second lens located on the second cross section of the laser crystal, wherein the first lens and the second lens are adapted to reflect the induced light, the first light and the second light.

2. The laser device according to claim 1, wherein the gain medium enables the laser crystal to be equipped with a first energy level, a second energy level and a third energy level, each of the first energy level, the second energy level, and the third energy level is associated with a plurality of atoms, when the atoms at the third energy level are migrated to the second energy level by transition, a first light with a first wavelength is generated, and a second light with a second wavelength is generated when the atoms at the second energy level are migrated to the first energy level by transition.

3. The laser device according to claim 2, wherein the induced light and the second light are different from each other by less than five percent in wavelength, and the induced light enables the atoms at the second energy level to migrate to the first energy level by transition.

4. The laser device according to claim 2, wherein the third light enables the atoms at the first energy level of the laser crystal to elevate to the second energy level and the third energy level by transition, or the atoms at the second energy level to elevate to the third energy level by transition.

5. The laser device according to claim 2, wherein the gain medium is erbium.

6. The laser device according to claim 2, wherein a wavelength of the third light ranges from 940 nm to 990 nm, the first wavelength ranges from 2650 nm to 3000 nm, and the second wavelength ranges between 1500 nm and 1650 nm.

7. The laser device according to claim 6, wherein the gain medium is erbium, a wavelength of the induced light differs from the second wavelength by less than five percent, and the induced light induces the atoms at the second energy level to migrate to the first energy level by transition, the third light enables the atoms at the first energy level of the laser crystal to migrate to the second energy level and the third energy level by transition or the atoms at the second energy level to migrate to the third energy level by transition.

8. The laser device according to claim 7, wherein the reflection ratio of the first lens to the first wavelength of the first light is greater than the reflection ratio of the second lens to the first wavelength of the first light, and the reflection ratio of the second lens to the second wavelength of the second light is greater than the reflection ratio of the first lens to the second wavelength of the second light.

9. The laser device according to claim 1, wherein the penetration ratio of the second lens to the first wavelength of the first light is greater than the penetration ratio of the first lens to the first wavelength of the first light, and the penetration ratio of the first lens to the second wavelength of the second light is greater than the penetration ratio of the second lens to the second wavelength of the second light.

10. The laser device according to claim 1, wherein the first light is for bio-medical treatment purpose when the third light source is a pumping light source.

11. The laser device according to claim 1, wherein the first lens is directly formed on the first cross section, and the second lens is directly formed on the second cross section.

12. The laser device according to claim 1, wherein the third light penetrates into the laser crystal through a side surface of the laser crystal.

13. The laser device according to claim 1, wherein the third light penetrates into the laser crystal via the first lens.

14. A method of generating a laser light, comprising:
emitting a third light associated with a third wavelength into a laser crystal, wherein the laser crystal comprises a gain medium, the gain medium enables the laser crystal to have a first energy level, a second energy level, and a third energy level, each of the first energy level, the second energy level, and the third energy level has a plurality of atoms, when the atoms at the third energy level are migrated to the second energy level by transition, a first light associated with a first wavelength is generated, and when the atoms at the second energy level are migrated to the first energy level by transition, a second light associated with a second wavelength is generated; and
emitting an induced light into the laser crystal to induce the atoms at the second energy level to transition to the first energy level, wherein a wavelength of the induced light differs from the second wavelength by less than five percent.

15. The method according to claim 14, wherein the laser crystal further comprises a first cross section and a second cross section, the method further comprises:
causing the first light associated with the first wavelength to be reflected from the first cross section; and
causing the second light associated with the second wavelength to be reflected from the second section and eighty percent of the second light associated with the second wavelength to be reflected from the second cross section.

16. The method according to claim 14, wherein the gain medium is erbium.

17. The method according to claim 16, wherein the first wavelength ranges from 2650 nm to 3000 nm.

18. The method according to claim 17, wherein the second wavelength ranges from 1500 nm to 1650 nm.

19. The method according to claim 18, wherein the third wavelength ranges from 940 nm to 990 nm.

20. The method according to claim 16, wherein the first light is for bio-medical treatment purpose.

21. The method according to claim 16, wherein the third light is a pumping light.

22. The method according to claim 14, wherein the gain medium is erbium, the third light is a pumping light, the first wavelength is between 2650 nm to 3000 nm, the second wavelength ranges from 1500 nm to 1650 nm, and the third wavelength ranges from 940 nm to 990 nm.

23. The method according to claim 22, wherein the first light is for bio-medical purpose and the third light is a pumping light.
